(19) United States
(12) Patent Application Publication
(10) Pub. No.: US 2018/0053938 A1
(43) Pub. Date: Feb. 22, 2018

(54) ELECTRODE BINDER, CATHODE ELECTRODE MATERIAL, AND LITHIUM ION BATTERY

(71) Applicants: Jiangsu Huadong Institute of Li-Ion Battery Co., Ltd., Suzhou (CN); Tsinghua University, Beijing (CN)

(72) Inventors: XIANG-MING HE, Beijing (CN); GUAN-NAN QIAN, Suzhou (CN); LI WANG, Beijing (CN); YU-MING SHANG, Beijing (CN); JIAN-JUN LI, Beijing (CN); YAO-WU WANG, Beijing (CN)

(73) Assignees: Jiangsu Huadong Institute of Li-Ion Battery Co., Ltd., Suzhou (CN); Tsinghua University, Beijing (CN)

(21) Appl. No.: 15/792,765

(22) Filed: Oct. 25, 2017

Related U.S. Application Data
(63) Continuation of application No. PCT/CN2016/078459, filed on Apr. 5, 2016.

(30) Foreign Application Priority Data
Apr. 27, 2015 (CN) 201510204457.9

(51) Int. Cl. H01M 4/62; C08G 73/10; H01M 10/0525

(52) U.S. Cl. CPC H01M 4/622; C08G 73/1007; H01M 2004/028; H01M 10/0525; C08G 73/106

(57) ABSTRACT

An electrode binder, a cathode electrode material and a lithium ion battery are disclosed. The cathode electrode material includes the cathode binder. The cathode binder includes a polymer obtained by polymerizing a dianhydride monomer with a diamine monomer. At least one of the dianhydride monomer and the diamine monomer includes a silicon-containing monomer. The lithium ion battery includes an anode electrode, an electrolyte, a separator, and the cathode electrode, the cathode electrode includes a cathode active material, a conducting agent, and the cathode binder.

### CROSS-REFERENCE TO RELATED APPLICATIONS

This application claims all benefits accruing under 35 U.S.C. § 119 from China Patent Application No. 201510204457.9, filed on Apr. 27, 2015 in the State Intellectual Property Office of China, the content of which is hereby incorporated by reference. This application is a continuation under 35 U.S.C. § 120 of international patent application PCT/CN2016/078459 filed on Apr. 5, 2016, the content of which is also hereby incorporated by reference.

### FIELD

The present disclosure relates to new types of electrode binders for lithium ion batteries, cathode electrode materials, and lithium ion batteries using the electrode binders.

### BACKGROUND

Binder is an important component of a cathode electrode and an anode electrode of a lithium ion battery. The binder is a high molecular weight compound for adhering an electrode active material to a current collector. A main role of the binder is to adhere and maintain the electrode active material, stabilize the electrode structure, and buffer an expansion and contraction of the electrode during a charge and discharge process. Besides having an adhering ability, the binder used in the lithium ion battery should be stable in an operation voltage range and temperature range, have relatively low inherent resistance to avoid obstructing normal charge and discharge cycling, and be insoluble to the organic solvent that is used in an electrolyte liquid of the lithium ion battery. A commonly used binder in lithium ion batteries is organic fluorine-containing polymers, such as polyvinylidene fluoride (PVDF).

### SUMMARY

What is needed, therefore, is to provide an electrode binder, a cathode electrode material, and a lithium ion battery using the electrode binder.

An electrode binder of a lithium ion battery comprises a polymer obtained by polymerizing a dianhydride monomer with a diamine monomer, wherein at least one of the dianhydride monomer and the diamine monomer comprises a silicon-containing monomer. When the dianhydride monomer comprises the silicon-containing monomer, the silicon-containing dianhydride monomer is represented by formula (1). When the diamine monomer comprises the silicon-containing monomer, the silicon-containing diamine monomer is represented by formula (2). R₁ and R₂ are silicon-containing bivalent organic substituents.

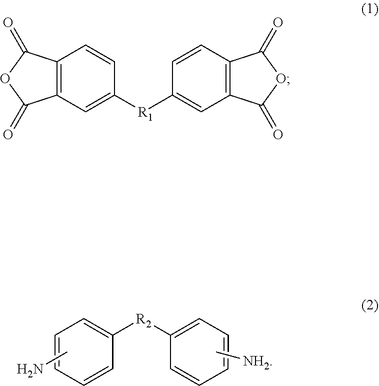

A cathode electrode material comprises the above-described electrode binder.

A lithium ion battery comprises a cathode electrode; an electrolyte; a separator; and an anode electrode. The cathode electrode comprises the above-described cathode electrode material.

The polymer obtained by polymerizing the dianhydride monomer with the diamine monomer has a good binding force and does not affect the normal charge and discharge cycling performance of the battery in the charge and discharge voltage range of the cathode electrode of the lithium ion battery, can be used as a binder and have an over-charge protection to the cathode electrode.

### BRIEF DESCRIPTION OF THE DRAWINGS

FIG. 1 is a graph showing cycling performances of Example 11 and Comparative Example 8 of lithium ion batteries.

FIG. 2 is a graph showing voltage-time curve and temperature-time curve of Example 11 of the lithium ion battery being overcharged.

FIG. 3 is a graph showing voltage-time curve and temperature-time curve of Comparative Example 8 of the lithium ion battery being overcharged.

Implementations are described by way of example only with reference to the attached figure.

### DETAILED DESCRIPTION

A detailed description with the above drawing is made to further illustrate the present disclosure.

One embodiment of a cathode binder is provided. The cathode binder is a polymer obtained by polymerizing a dianhydride monomer with a diamine monomer. At least one of the dianhydride monomer and the diamine monomer comprises a monomer containing silicon atom.

In one embodiment, the dianhydride monomer comprises the silicon-containing monomer, and the silicon contained dianhydride monomer can be represented by formula (1).

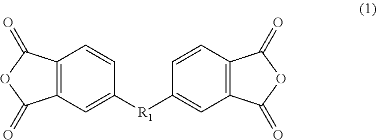

In another embodiment, the diamine monomer comprises the silicon-containing monomer, and the silicon-containing diamine monomer can be represented by formula (2).

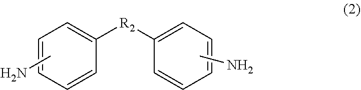

R₁ in formula (1) and R₂ in formula (2) are both silicon-containing bivalent organic substituents, which can be independently selected from

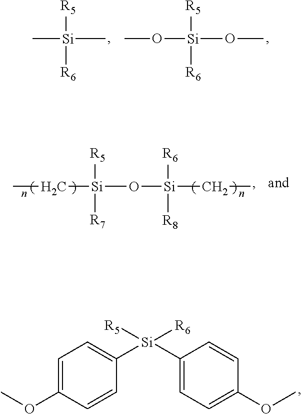

wherein n=1 to 6; R₅, R₆, R₇, and R₈ can be independently selected from an alkyl group with 1 to 6 carbon atoms, an alkoxy group with 1 to 6 carbon atoms, a monovalent alicyclic group, a monovalent substituted alicyclic group, a monovalent aromatic group, a monovalent substituted aromatic group, —C(O)R, —RS(O)R, —RNH₂R, wherein R is an alkyl group with 1 to 6 carbon atoms. A hydrogen atom of the monovalent alicyclic group or the monovalent aromatic group can be substituted by a halogen atom or an alkyl group with 1 to 6 carbon atoms to form the monovalent substituted alicyclic group or the monovalent substituted aromatic group. The monovalent substituted aromatic group or the monovalent aromatic group can have 1 or 2 benzene rings, and in some embodiments can be phenyl group, methyl phenyl group, or dimethyl phenyl group. R₅, R₆, R₇, and R₈ can be the same or different.

In some embodiments, R₁ in formula (1) and R₂ in formula (2) can be independently selected from

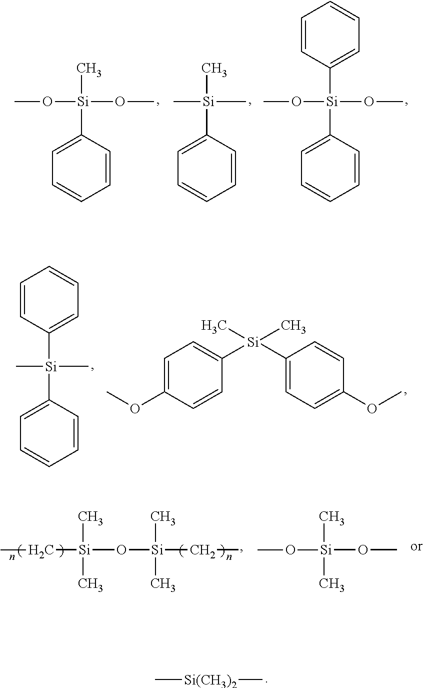

When the diamine monomer comprises the silicon-containing monomer, the dianhydride monomer does not need to contain silicon atom, and can be represented by formulas (3), (4), or (5).

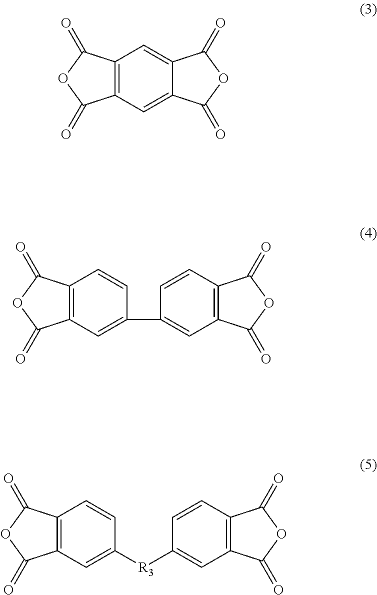

In formula (5), R₃ is a bivalent organic substituent containing no silicon atoms, which can be —(CH₂)ₙ—, —O—, —S—, —CH₂—O—CH₂—,

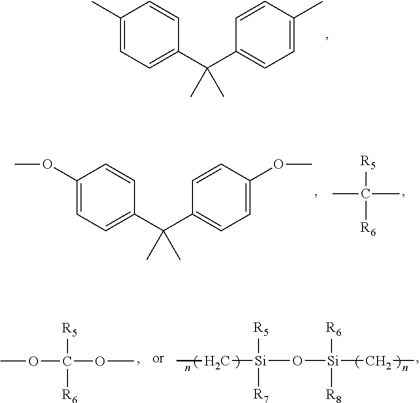

wherein n=1 to 6; R₅, R₆, R₇, and R₈ can be independently selected from H atom, an alkyl group with 1 to 6 carbon atoms, an alkoxy group with 1 to 6 carbon atoms, a monovalent alicyclic group, a monovalent substituted alicyclic group, a monovalent aromatic group, a monovalent substituted aromatic group, —C(O)R, —RS(O)R, —RNH₂R, wherein R is an alkyl group with 1 to 6 carbon atoms. A hydrogen atom of the monovalent alicyclic group or the monovalent aromatic group can be substituted by a halogen atom or an alkyl group with 1 to 6 carbon atoms to form the monovalent substituted alicyclic group or the monovalent substituted aromatic group. The monovalent substituted aromatic group or the monovalent aromatic group can have 1 or 2 benzene rings, and in some embodiments can be phenyl group, methyl phenyl group, or dimethyl phenyl group.

When the dianhydride monomer comprises the silicon-containing monomer, the diamine monomer does not need to contain silicon atom, and comprises a monomer represented by formula (6) below.

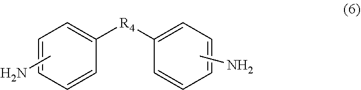

In formula (6), R₄ is a bivalent organic substituent containing no silicon atom, which can be —(CH₂)n-, —O—, —S—, —CH₂—O—CH₂—, —CH(NH)—(CH₂)ₙ—,

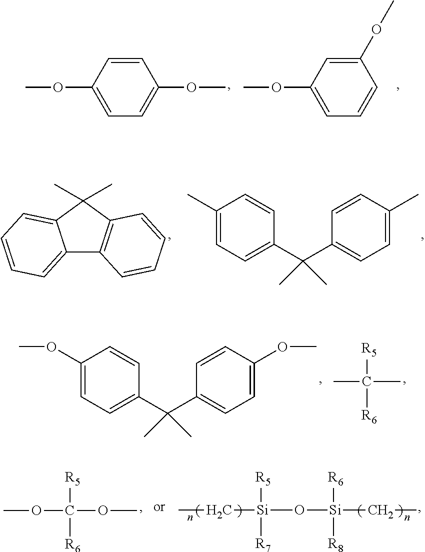

wherein n=1 to 6; R₅, R₆, R₇, and R₈ can be independently selected from H atom, an alkyl group with 1 to 6 carbon atoms, an alkoxy group with 1 to 6 carbon atoms, a monovalent alicyclic group, a monovalent substituted alicyclic group, a monovalent aromatic group, a monovalent substituted aromatic group, —C(O)R, —RS(O)R, —RNH₂R, wherein R is an alkyl group with 1 to 6 carbon atoms. A hydrogen atom of the monovalent alicyclic group or the monovalent aromatic group can be substituted by a halogen atom or an alkyl group with 1 to 6 carbon atoms to form the monovalent substituted alicyclic group or the monovalent substituted aromatic group. The monovalent substituted aromatic group or the monovalent aromatic group can have 1 or 2 benzene rings, and in some embodiments can be phenyl group, methyl phenyl group, or dimethyl phenyl group.

When the diamine monomer comprises the silicon-containing monomer, the diamine monomer can further comprise a silicon-free monomer, which can be a monomer represented by formula (6).

When the dianhydride monomer comprises the silicon-containing monomer, the dianhydride monomer can further comprise a silicon-free monomer, which can be a monomer represented by formula (3), (4), or (5).

When the diamine monomer and the dianhydride monomer both comprise the silicon-containing monomers, the diamine monomer and the dianhydride monomer can further comprise silicon-free monomer, which can be a monomer represented by formula (6) and a monomer represented by formula (3), (4), or (5).

A molar ratio of a total amount of the silicon-containing monomer (the silicon-containing diamine monomer and/or the silicon-containing dianhydride monomer) to a total amount of the silicon-free monomer (the diamine monomer containing no silicon atom and/or the dianhydride monomer containing no silicon atom) can be 1:100 to 10:1, such as 1:20 to 1:1.

In one embodiment, the diamine monomer and the dianhydride monomer both only comprise the silicon-containing monomers.

A molar ratio of all the dianhydride monomer to all the diamine monomer can be 1:10 to 10:1, and in some embodiments can be 1:2 to 4:1.

A molecular weight of the polymer obtained by polymerizing the dianhydride monomer with the diamine monomer can be in a range from about 10000 to about 600000.

The electrode binder of the lithium ion battery can be used as a cathode binder in a cathode electrode material of the lithium ion battery.

One embodiment of a method for making the electrode binder of the lithium ion battery comprises a step of polymerizing the dianhydride monomer with the diamine monomer, which specifically can comprise:
mixing the dianhydride monomer and the diamine monomer in an organic solvent to form a mixture, and heating and stirring the mixture to fully carry the reaction thereby obtaining the binder.

The diamine monomer can be dissolved in an organic solvent to form a diamine solution. A mass ratio of the diamine monomer to the organic solvent in the diamine solution can be 1:100 to 1:1, and can be 1:10 to 1:2 in some embodiments.

The dianhydride monomer can be dissolved in an organic solvent to form a dianhydride solution. A mass ratio of the dianhydride monomer to the organic solvent in the dianhydride solution can be 1:100 to 1:1, and can be 1:10 to 1:2 in some embodiments.

The organic solvent can dissolve the diamine monomer and the dianhydride monomer, such as m-cresol, N,N-dimethylformamide, N,N-dimethylacetamide, propylene carbonate, and N-methyl-2-pyrrolidone (NMP).

A pump can be used to transfer the dianhydride solution to the diamine solution or transfer the diamine solution to the dianhydride solution. After the transferring, the stirring can continue for a period of time to form a complete reaction. The stirring can last for about 2 hours to about 72 hours, and about 12 hours to about 24 hours in some embodiments. The temperature of the polymerizing can be at about 160° C. to about 200° C.

During the polymerizing, a catalyst can be added. The catalyst can be at least one of benzoic acid, benzenesulfonic acid, phenylacetic acid, pyridine, quinoline, pyrrole, and imidazole. A mass percentage of the catalyst to a sum of the dianhydride monomer and the diamine monomer can be about 0.5% to about 5%.

First, the dianhydride monomer and the diamine monomer can be completely dissolved in the organic solvent, and then heated to a temperature of about 30° C. to about 60° C. at which the mixture is stirred for about 1 hour to about 10 hours, and 2 hours to 4 hours in some embodiments. The catalyst is then added to the mixture followed by heating the mixture to a temperature of about 160° C. to about 200° C. at which the mixture is stirred for about 6 hours to about 48 hours, and 12 hours to 24 hours in some embodiments, to obtain the polymer.

After the reaction, the electrode binder can be purified by washing the obtained polymer with a cleaning solvent, and dried. The catalyst and the organic solvent are soluble to the cleaning solvent, and the electrode binder is insoluble to the cleaning solvent to form a precipitate. The cleaning solvent can be water, methanol, ethanol, a mixture of methanol and water, or a mixture of ethanol and water (a concentration of the methanol or the ethanol can be 5 wt % to 99 wt %).

One embodiment of a cathode electrode material comprises a cathode active material, a conducting agent, and the above-described cathode binder, which are uniformly mixed with each other. A mass percentage of the cathode binder in the cathode electrode material can be in a range from about 0.01% to about 30%, such as from about 1% to about 8%.

The cathode active material can be at least one of layer type lithium transition metal oxides, spinel type lithium transition metal oxides, and olivine type lithium transition metal oxides, such as olivine type lithium iron phosphate, layer type lithium cobalt oxide, layer type lithium manganese oxide, spinel type lithium manganese oxide, lithium nickel manganese oxide, and lithium cobalt nickel manganese oxide.

The conducting agent can be carbonaceous materials, such as at least one of carbon black, conducting polymers, acetylene black, carbon fibers, carbon nanotubes, and graphite.

One embodiment of an anode electrode material comprises an anode active material, the conducting agent, and an anode binder, which are uniformly mixed with each other. The anode binder is the polymer obtained by polymerizing the dianhydride monomer with the diamine monomer. A mass percentage of the anode binder in the anode electrode material can be in a range from about 0.01% to about 50%, such as from about 1% to about 20%.

The anode active material can be at least one of lithium titanate, graphite, mesophase carbon microbeads (MCMB), acetylene black, carbon fibers, carbon nanotubes, and cracked carbon.

One embodiment of a lithium ion battery comprises a cathode electrode, an anode electrode, a separator, and an electrolyte liquid. The cathode electrode and the anode electrode are spaced from each other by the separator. At least one of the cathode electrode and the anode electrode comprises the above-described electrode binder comprising the polymer obtained by polymerizing the dianhydride monomer with the diamine monomer. The cathode electrode can further comprise a cathode current collector and the cathode electrode material located on a surface of the cathode current collector. The anode electrode can further comprise an anode current collector and an anode electrode material located on a surface of the anode current collector. The anode electrode material and the cathode electrode material are opposite to each other and spaced by the separator.

When the cathode electrode material comprises the cathode binder which comprises the polymer obtained by polymerizing the dianhydride monomer with the diamine monomer, the anode electrode material can adopt a conventional binder. When the anode electrode material comprises the anode binder which comprises the polymer obtained by polymerizing the dianhydride monomer with the diamine monomer, the cathode electrode material can adopt a conventional binder. The conventional binder can be at least one of polyvinylidene fluoride (PVDF), polyvinylidene fluoride, polytetrafluoroethylene (PTFE), fluoro rubber, ethylene propylene diene monomer, and styrene-butadiene rubber (SBR). In one embodiment, both the cathode electrode and the anode electrode comprise the electrode binder comprising the polymer obtained by polymerizing the dianhydride monomer with the diamine monomer.

The separator can be polyolefin microporous membrane, modified polypropylene fabric, polyethylene fabric, glass fiber fabric, superfine glass fiber paper, vinylon fabric, or composite membrane of nylon fabric, and wettable polyolefin microporous membrane composited by welding or bonding.

The electrolyte liquid comprises a lithium salt and a non-aqueous solvent. The non-aqueous solvent can comprise at least one of cyclic carbonates, chain carbonates, cyclic ethers, chain ethers, nitriles, amides and combinations thereof, such as one or more of ethylene carbonate (EC), diethyl carbonate (DEC), propylene carbonate (PC), dimethyl carbonate (DMC), ethyl methyl carbonate (EMC), butylene carbonate, gamma-butyrolactone, gamma-valerolactone, dipropyl carbonate, N-methyl pyrrolidone (NMP), N-methylformamide, N-methylacetamide, N,N-dimethylformamide, N,N-diethylformamide, diethyl ether, acetonitrile, propionitrile, anisole, succinonitrile, adiponitrile, glutaronitrile, dimethyl sulfoxide, dimethyl sulfite, vinylene carbonate, ethyl methyl carbonate, dimethyl carbonate, diethyl carbonate, fluoroethylene carbonate, chloropropylene carbonate, anhydride, sulfolane, methoxymethylsulfone, tetrahydrofuran, 2-methyltetrahydrofuran, epoxy propane, methyl acetate, ethyl acetate, propyl acetate, methyl butyrate, ethyl propionate, methyl propionate, dimethylformamide, 1,3-dioxolane, 1,2-diethoxyethane, 1,2-dimethoxyethane, and 1,2-dibutoxy.

The lithium salt can comprise at least one of lithium chloride (LiCl), lithium hexafluorophosphate (LiPF₆), lithium tetrafluoroborate (LiBF₄), lithium methanesulfonate (LiCH₃SO₃), lithium trifluoromethanesulfonate (LiCF₃SO₃), lithium hexafluoroarsenate (LiAsF₆), lithium hexafluoroantimonate (LiSbF₆), lithium perchlorate (LiClO₄), Li[BF₂(C₂O₄)], Li[PF₂(C₂O₄)₂], Li[N(CF₃SO₂)₂], Li[C(CF₃SO₂)₃], and lithium bisoxalatoborate (LiBOB).

Example: Electrode Binder

### EXAMPLE 1

In molar ratio, 0.4 parts of bis(4-aminophenoxy)dimethylsilane, 0.6 parts of 4,4′-oxydianiline (ODA), and m-cresol as the organic solvent are added in a triple-neck flask (a solid content of the solution is about 10%), stirred at room temperature to dissolve completely. 1 part of 2,3,3′,4′-diphenyl ether tetracarboxylic dianhydride is then added and dissolved completely. The solution is heated to about 50° C. and reacted for about 4 hours followed by adding 1.5 mL of benzoic acid as the catalyst. Then the solution is heated to about 180° C. and reacted for about 24 hours. Finally, the reaction is terminated and the solution is precipitated in methanol to obtain the cathode binder, which is a fiber shaped polymer represented by formula (7).

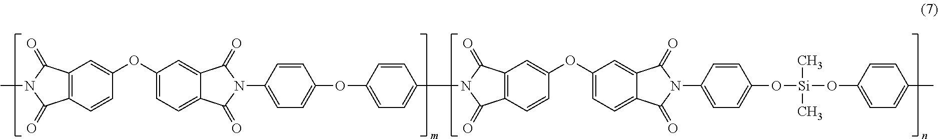

### EXAMPLE 2

In molar ratio, 0.4 parts of bis(4-aminophenoxy)diphenylsilane, 0.6 parts of 4,4′-oxydianiline (ODA), and m-cresol as the organic solvent are added in a triple-neck flask (a solid content of the solution is about 10%), stirred at room temperature to dissolve completely. 1 part of 2,3,3′,4′-diphenyl ether tetracarboxylic dianhydride is then added and dissolved completely. The solution is heated to about 50° C. and reacted for about 4 hours followed by adding 1.5 mL of benzoic acid as the catalyst. Then the solution is heated to about 180° C. and reacted for about 24 hours. Finally, the reaction is terminated and the solution is precipitated in methanol to obtain the cathode binder, which is a fiber shaped polymer represented by formula (8).

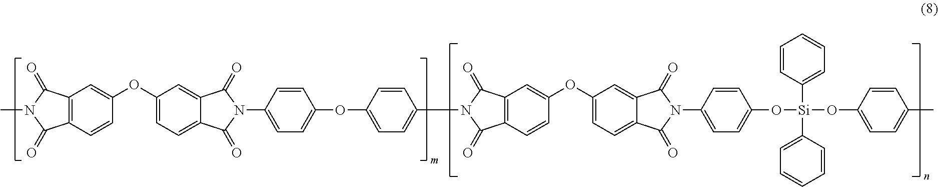

### EXAMPLE 3

In molar ratio, 0.4 parts of bis(4-aminophenoxy)dimethylsilane, 0.6 parts of 4,4′-oxydianiline (ODA), and m-cresol as the organic solvent are added in a triple-neck flask (a solid content of the solution is about 10%), stirred at room temperature to dissolve completely. 1 part of bis(dimethylsilyl)benzotetracarboxylic dianhydride

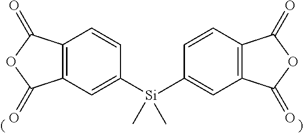 [SMILES: C[Si](C)(c1ccc2c(c1)C(=O)OC2=O)c1ccc2c(c1)C(=O)OC2=O]

is then added and dissolved completely. The solution is heated to about 50° C. and reacted for about 4 hours followed by adding 1.5 mL of benzoic acid as the catalyst. Then the solution is heated to about 180° C. and reacted for about 24 hours. Finally, the reaction is terminated and the solution is precipitated in methanol to obtain the cathode binder, which is a fiber shaped polymer represented by formula (9).

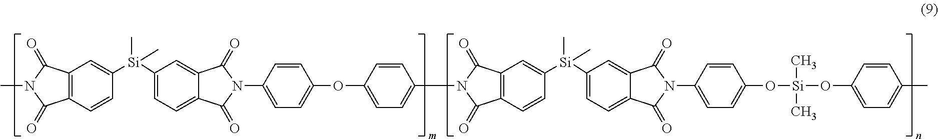

### EXAMPLE 4

In molar ratio, 0.4 parts of 2,2′-bis(4-aminophenoxyphenyl)propane (BAPP), 0.6 parts of 4,4′-oxydianiline (ODA), and m-cresol as the organic solvent are added in a triple-neck flask (a solid content of the solution is about 10%), stirred at room temperature to dissolve completely. 1 part of bis(dimethylsilyl)benzotetracarboxylic dianhydride

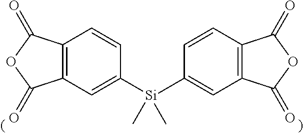 [SMILES: C[Si](C)(c1ccc2c(c1)C(=O)OC2=O)c1ccc2c(c1)C(=O)OC2=O]

is then added and dissolved completely. The solution is heated to about 50° C. and reacted for about 4 hours followed by adding 1.5 mL of benzoic acid as the catalyst. Then the solution is heated to about 180° C. and reacted for about 24 hours. Finally, the reaction is terminated and the solution is precipitated in methanol to obtain the cathode binder, which is a fiber shaped polymer represented by formula (10).

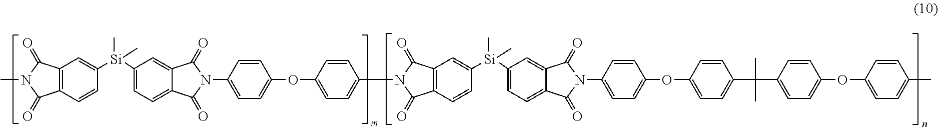

Example: Half Cell

### EXAMPLE 5

90% of LiNi_{1/3}Co_{1/3}Mn_{1/3}O₂, 2% of the cathode binder obtained in Example 1, and 8% of the conducting graphite by mass percent are mixed and dispersed by NMP to form a slurry. The slurry is coated on an aluminum foil and vacuum dried at about 120° C. for about 12 hours to obtain the cathode electrode. The counter electrode is lithium metal. The electrolyte liquid is 1 M of LiPF₆ dissolved in a solvent mixture of EC/DEC/EMC=1/1/1 (v/v/v). The cathode electrode, the counter electrode, and the electrolyte liquid are assembled to form a 2032 coin type lithium ion battery.

### EXAMPLE 6

88% of LiNi_{1/3}Co_{1/3}Mn_{1/3}O₂, 5% of the cathode binder obtained in Example 1, and 7% of the conducting graphite by mass percent are mixed and dispersed by NMP to form a slurry. The slurry is coated on an aluminum foil and vacuum dried at about 120° C. for about 12 hours to obtain the cathode electrode. The counter electrode is lithium metal. The electrolyte liquid is 1 M of LiPF₆ dissolved in a solvent mixture of EC/DEC/EMC=1/1/1 (v/v/v). The cathode electrode, the counter electrode, and the electrolyte liquid are assembled to form a 2032 coin type lithium ion battery.

### EXAMPLE 7

80% of LiNi_{1/3}Co_{1/3}Mn_{1/3}O₂, 10% of the cathode binder obtained in Example 1, and 10% of the conducting graphite by mass percent are mixed and dispersed by NMP to form a slurry. The slurry is coated on an aluminum foil and vacuum dried at about 120° C. for about 12 hours to obtain the cathode electrode. The counter electrode is lithium metal. The electrolyte liquid is 1 M of LiPF₆ dissolved in a solvent mixture of EC/DEC/EMC=1/1/1 (v/v/v). The cathode electrode, the counter electrode, and the electrolyte liquid are assembled to form a 2032 coin type lithium ion battery.

### EXAMPLE 8

88% of LiNi_{1/3}Co_{1/3}Mn_{1/3}O₂, 5% of the cathode binder obtained in Example 2, and 7% of the conducting graphite by mass percent are mixed and dispersed by NMP to form a slurry. The slurry is coated on an aluminum foil and vacuum dried at about 120° C. for about 12 hours to obtain the cathode electrode. The counter electrode is lithium metal. The electrolyte liquid is 1 M of LiPF₆ dissolved in a solvent mixture of EC/DEC/EMC=1/1/1 (v/v/v). The cathode electrode, the counter electrode, and the electrolyte liquid are assembled to form a 2032 coin type lithium ion battery.

### EXAMPLE 9

88% of LiNi_{1/3}Co_{1/3}Mn_{1/3}O₂, 5% of the cathode binder obtained in Example 3, and 7% of the conducting graphite by mass percent are mixed and dispersed by NMP to form a slurry. The slurry is coated on an aluminum foil and vacuum dried at about 120° C. for about 12 hours to obtain the cathode electrode. The counter electrode is lithium metal. The electrolyte liquid is 1 M of LiPF₆ dissolved in a solvent mixture of EC/DEC/EMC=1/1/1 (v/v/v). The cathode electrode, the counter electrode, and the electrolyte liquid are assembled to form a 2032 coin type lithium ion battery.

### EXAMPLE 10

88% of LiNi_{1/3}Co_{1/3}Mn_{1/3}O₂, 5% of the cathode binder obtained in Example 4, and 7% of the conducting graphite by mass percent are mixed and dispersed by NMP to form a slurry. The slurry is coated on an aluminum foil and vacuum dried at about 120° C. for about 12 hours to obtain the cathode electrode. The counter electrode is lithium metal. The electrolyte liquid is 1 M of LiPF₆ dissolved in a solvent mixture of EC/DEC/EMC=1/1/1 (v/v/v). The cathode electrode, the counter electrode, and the electrolyte liquid are assembled to form a 2032 coin type lithium ion battery.

Example: Full Cell

### EXAMPLE 11

94% of LiNi_{1/3}Co_{1/3}Mn_{1/3}O₂, 3% of the cathode binder obtained in Example 1, and 3% of the conducting graphite by mass percent are mixed and dispersed by the NMP to form a slurry. The slurry is coated on an aluminum foil and vacuum dried at about 120° C. for about 12 hours to obtain the cathode electrode.

94% of anode graphite, 3.5% of PVDF, and 2.5% of the conducting graphite by mass percent are mixed and dispersed by the NMP to form a slurry. The slurry is coated on a copper foil and vacuum dried at about 100° C. to obtain the anode electrode.

The cathode electrode and the anode electrode are assembled and rolled up to form a 63.5 mm×51.5 mm×4.0 mm sized soft packaged battery. The electrolyte liquid is 1 M of LiPF₆ dissolved in a solvent mixture of EC/DEC/EMC=1/1/1 (v/v/v).

Comparative Example: Cathode Binder

### COMPARATIVE EXAMPLE 1

In molar ratio, 0.4 parts of 2,2′-bis(4-aminophenoxyphenyl)propane (BAPP), 0.6 parts of 4,4′-oxydianiline (ODA), and m-cresol as the organic solvent are added in a triple-neck flask (a solid content of the solution is about 10%), stirred at room temperature to dissolve completely. 1 part of 2,3,3′,4′-diphenyl ether tetracarboxylic dianhydride is then added and dissolved completely. The solution is heated to about 50° C. and reacted for about 4 hours followed by adding 1.5 mL of benzoic acid as the catalyst. Then the solution is heated to about 180° C. and reacted for about 24 hours. Finally, the reaction is terminated and the solution is precipitated in methanol to obtain the cathode binder, which is a fiber shaped polymer represented by formula (11).

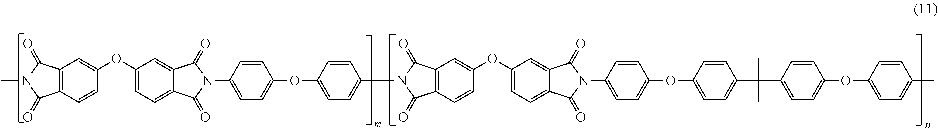

Comparative Example: Half Cell

### COMPARATIVE EXAMPLE 2

90% of LiNi_{1/3}Co_{1/3}Mn_{1/3}O₂, 2% of the cathode binder obtained in Comparative Example 1, and 8% of the conducting graphite by mass percent are mixed and dispersed by NMP to form a slurry. The slurry is coated on an aluminum foil and vacuum dried at about 120° C. for about 12 hours to obtain the anode electrode. The counter electrode is lithium metal. The electrolyte liquid is 1 M of LiPF₆ dissolved in a solvent mixture of EC/DEC/EMC=1/1/1 (v/v/v). The cathode electrode, the counter electrode, and the electrolyte liquid are assembled to form a 2032 coin type lithium ion battery.

### COMPARATIVE EXAMPLE 3

88% of LiNi_{1/3}Co_{1/3}Mn_{1/3}O₂, 5% of the cathode binder obtained in Comparative Example 1, and 7% of the conducting graphite by mass percent are mixed and dispersed by NMP to form a slurry. The slurry is coated on an aluminum foil and vacuum dried at about 120° C. for about 12 hours to obtain the cathode electrode. The counter electrode is lithium metal. The electrolyte liquid is 1 M of LiPF₆ dissolved in a solvent mixture of EC/DEC/EMC=1/1/1 (v/v/v). The cathode electrode, the counter electrode, and the electrolyte liquid are assembled to form a 2032 coin type lithium ion battery.

### COMPARATIVE EXAMPLE 4

80% of LiNi_{1/3}Co_{1/3}Mn_{1/3}O₂, 10% of the anode binder obtained in Comparative Example 1, and 10% of the conducting graphite by mass percent are mixed and dispersed by NMP to form a slurry. The slurry is coated on an aluminum foil and vacuum dried at about 120° C. for about 12 hours to obtain the cathode electrode. The counter electrode is lithium metal. The electrolyte liquid is 1 M of LiPF₆ dissolved in a solvent mixture of EC/DEC/EMC=1/1/1 (v/v/v). The cathode electrode, the counter electrode, and the electrolyte liquid are assembled to form a 2032 coin type lithium ion battery.

### COMPARATIVE EXAMPLE 5

90% of LiNi_{1/3}Co_{1/3}Mn_{1/3}O₂, 2% of PVDF, and 8% of the conducting graphite by mass percent are mixed and dispersed by NMP to form a slurry. The slurry is coated on an aluminum foil and vacuum dried at about 120° C. for about 12 hours to obtain the cathode electrode. The counter electrode is lithium metal. The electrolyte liquid is 1 M of LiPF₆ dissolved in a solvent mixture of EC/DEC/EMC=1/1/1 (v/v/v). The cathode electrode, the counter electrode, and the electrolyte liquid are assembled to form a 2032 coin type lithium ion battery.

### COMPARATIVE EXAMPLE 6

88% of LiNi_{1/3}Co_{1/3}Mn_{1/3}O₂, 5% of PVDF, and 7% of the conducting graphite by mass percent are mixed and dispersed by NMP to form a slurry. The slurry is coated on an aluminum foil and vacuum dried at about 120° C. for about 12 hours to obtain the cathode electrode. The counter electrode is lithium metal. The electrolyte liquid is 1 M of LiPF₆ dissolved in a solvent mixture of EC/DEC/EMC=1/1/1 (v/v/v). The cathode electrode, the counter electrode, and the electrolyte liquid are assembled to form a 2032 coin type lithium ion battery.

### COMPARATIVE EXAMPLE 7

80% of LiNi_{1/3}Co_{1/3}Mn_{1/3}O₂, 10% of PVDF, and 10% of the conducting graphite by mass percent are mixed and dispersed by NMP to form a slurry. The slurry is coated on an aluminum foil and vacuum dried at about 120° C. for about 12 hours to obtain the cathode electrode. The counter electrode is lithium metal. The electrolyte liquid is 1 M of LiPF₆ dissolved in a solvent mixture of EC/DEC/EMC=1/1/1 (v/v/v). The cathode electrode, the counter electrode, and the electrolyte liquid are assembled to form a 2032 coin type lithium ion battery.

Comparative Example: Full Cell

### EXAMPLE 8

94% of LiNi_{1/3}Co_{1/3}Mn_{1/3}O₂, 3% of PVDF as the binder, and 3% of the conducting graphite by mass percent are mixed and dispersed by the NMP to form a slurry. The slurry is coated on an aluminum foil and vacuum dried at about 120° C. to obtain the cathode electrode.

94% of anode graphite, 3.5% of PVDF, and 2.5% of the conducting graphite by mass percent are mixed and dispersed by the NMP to form a slurry. The slurry is coated on a copper foil and vacuum dried at about 100° C. to obtain the anode electrode.

The cathode electrode and the anode electrode are assembled and rolled up to form a 63.5 mm×51.5 mm×4.0 mm sized soft packaged battery. The electrolyte liquid is 1 M of LiPF₆ dissolved in a solvent mixture of EC/DEC/EMC=1/1/1 (v/v/v).

Cycling Performance Test of Batteries

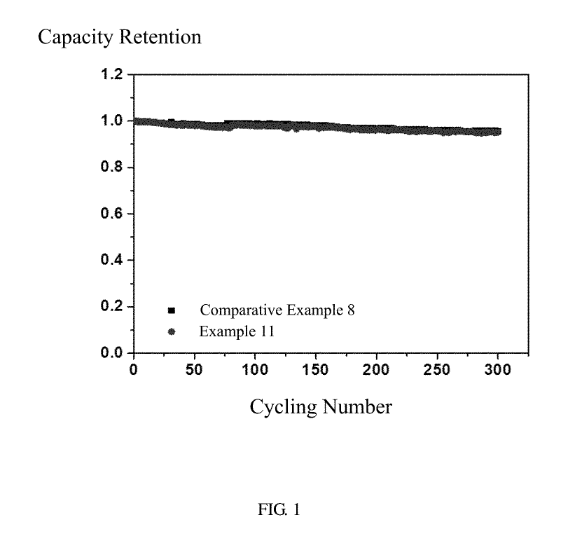

The lithium ion batteries of Examples 6, 8 to 11 and Comparative Examples 3, 6, 8 are charged and discharged to test the cycling performances. The test conditions are as follows: in the voltage range of 2.8V to 4.3V, the batteries are charged and discharged at a constant current rate (C-rate) of 0.2 C. Referring to FIG. 1 and Table 1, the cycling performance of the full cells of Example 11 and Comparative Example 8 for the first 300 cycles are shown in FIG. 1. The discharge efficiency of the first cycle, the discharge specific capacity at the 100^{th} cycle, and the capacity retention at the 100^{th} cycle of the lithium ion batteries of Examples 6, 8 to 10 and Comparative Examples 3, 6 are shown in Table 1. It can be seen that the cycling performances of the batteries in the present examples and the batteries using conventional binder PVDF are substantially the same.

TABLE 1

| | | | | Capacity |
|---|---|---|---|---|
| | Binder | Efficiency | Discharge specific | retention |
| | content | (%) at | capacity (mAh/g) at | (%) at 100^{th} |
| | (%) | 1st cycle | 100^{th} cycle | cycle |
| Example 6 | 5 | 88% | 147 | 95% |
| Example 8 | 5 | 84% | 142 | 92% |
| Example 9 | 5 | 86% | 146 | 94% |
| Example 10 | 5 | 86% | 145 | 93% |
| Comparative | 5 | 85% | 143 | 93% |
| Example 3 | | | | |
| Comparative | 5 | 85% | 144 | 94% |
| Example 6 | | | | |

Liquid Absorption Rate Test

The pristine cathode electrodes of Example 6 and Comparative Examples 5 and 6 are first weighed, and then immersed in an electrolyte liquid for about 48 hours. The cathode electrodes are taken out from the electrolyte liquid, and the residual electrolyte liquid are wiped off from the surface, and then the cathode electrodes are weighed again. Liquid absorption rate (R) is calculated by R=(M_{after}−M_{before})/M_{before}×100%, wherein M_{before} is the mass of the cathode electrode before being immersed in the electrolyte liquid, and Matter is the mass of the cathode electrode after being immersed in the electrolyte liquid. The R value for Example 6 is 13.6%, and the R values for Comparative Examples 5 and 6 are 12.5% and 18.0%. The cathode electrode of Example 6 has a liquid absorption rate, which is not higher than that using the conventional PVDF but can satisfy the need of the cathode binder in the lithium ion battery.

Binding Force Test

The binding force tests are carried out for the cathode electrodes of Examples 5 to 7 and Comparative Examples 2 to 7, respectively. Adhesive tape having a width of 20 mm±1 mm is used. First, 3 to 5 outer layers of the adhesive tape are peeled off, and then more than 150 mm long of the adhesive tape is taken. The adhesive tape does not contact a hand or any other object. One end of the adhesive tape is adhered to the cathode electrode, and the other end of the adhesive tape is connected to a holder. A roller under its own weight is rolled on the cathode electrode at a speed of about 300 mm/min back and forth over the entire length of the cathode electrode three times. The test is carried out after resting the cathode electrode in the test environment for about 20 minutes to about 40 minutes. The adhesive tape is peeled from the cathode electrode by a testing machine at a speed of about 300 mm/min±10 mm/min.

TABLE 2

| | | Sample | | |
|---|---|---|---|---|
| | Binder | Thickness/ | Sample | Maximum |
| | content/% | μm | Width/mm | load/N |
| Example 5 | 2 | 52 ± 2 | 20 | 4.90 |
| Example 6 | 5 | 52 ± 2 | 20 | 9.81 |
| Example 7 | 10 | 52 ± 2 | 20 | 14.60 |
| Comparative Example 2 | 2 | 52 ± 2 | 20 | 3.06 |
| Comparative Example 3 | 5 | 52 ± 2 | 20 | 8.72 |
| Comparative Example 4 | 10 | 52 ± 2 | 20 | 0.54 |
| Comparative Example 5 | 2 | 52 ± 2 | 20 | 1.29 |
| Comparative Example 6 | 5 | 52 ± 2 | 20 | 4.78 |
| Comparative Example 7 | 10 | 52 ± 2 | 20 | 6.30 |

As shown in Table 2, when the binder contents are 2% and 5%, the binding forces of the silicon-containing binders of Examples 5 to 6 are the highest, the silicon-free binders of Comparative Examples 2 to 3 are lower, and the PVDF binder of Comparative Examples 5 to 6 are the lowest. When the binder content is 10%, the binding force of the silicon-containing binder of Example 7 is the highest, and the binding force of the silicon-free binder of Comparative Example 4 is the lowest, which is weak to the current collector. The reason is that the silicon-free binder has a large molecular rigidity and does not have an atomic group having a strong adhesion to the current collector, so that the high content binder is easy to get off from the current collector with the evaporation of the solvent in the electrode production process. The silicon atoms can strengthen the binding force between the anode electrode material and the current collector.

Overcharge Test

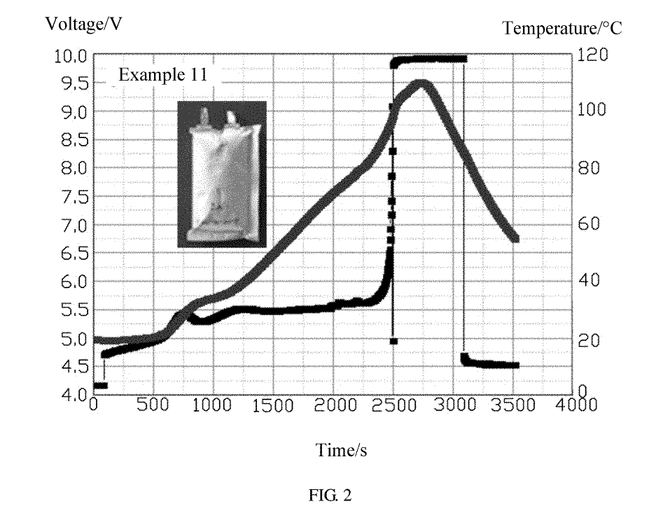

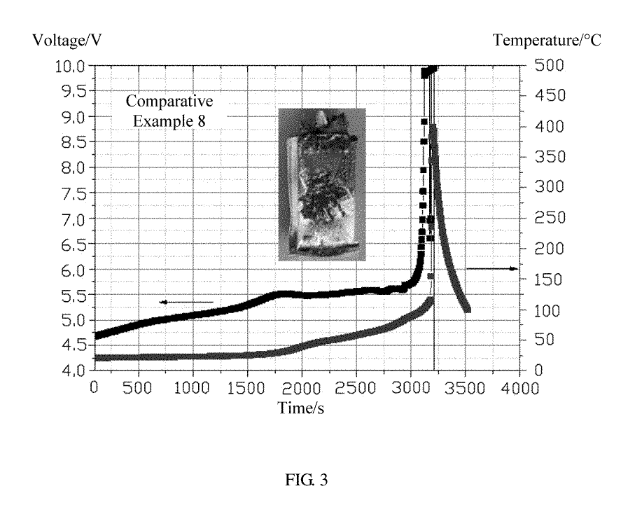

The lithium ion batteries of Example 11 and Comparative Example 8 are both overcharged to 10V at a current rate of 1 C to observe the phenomenon. Referring to FIG. 2, in Example 11, the highest temperature during the overcharge process of the battery is lower than 120° C. Referring to FIG. 3, the battery of Comparative Example 8 burns, and the temperature of the battery reaches 400° C.

In the present disclosure, the polymer obtained by polymerizing the dianhydride monomer with diamine monomer has a good binding force and does not affect the charge and discharge cycling performance of the lithium ion battery, and can be used as the cathode binder in the cathode electrode material of the lithium ion battery. The polymer can improve the electrode stability and the thermal stability of the lithium ion battery as an overcharge protection to the electrode.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. An electrode binder of a lithium ion battery, the electrode binder comprising a polymer obtained by polymerizing a dianhydride monomer with a diamine monomer, wherein at least one of the dianhydride monomer and the diamine monomer comprises a silicon-containing monomer.

2. The electrode binder of claim 1, wherein the dianhydride monomer comprises a first monomer represented by a formula (1), 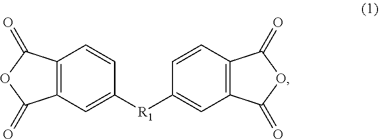
wherein R₁ is a first silicon-containing bivalent organic substituent.

3. The electrode binder of claim 1, wherein R₁ is selected from the group consisting of 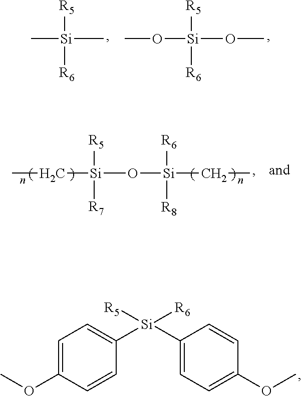
wherein n is in a range from 1 to 6; R₅, R₆, R₇, and R₈ are independently selected from the group consisting of an alkyl group with 1 to 6 carbon atoms, an alkoxy group with 1 to 6 carbon atoms, a monovalent alicyclic group, a monovalent substituted alicyclic group, a monovalent aromatic group, a monovalent substituted aromatic group, —C(O)R, —RS(O)R, and —RNH₂R, wherein R is an alkyl group with 1 to 6 carbon atoms.

4. The electrode binder of claim 1, wherein R₁ is selected from the group consisting of 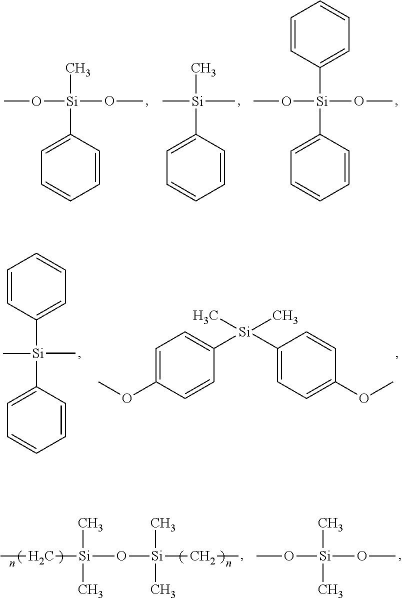
and —Si(CH₃)₂—.

5. The electrode binder of claim 1, wherein the diamine monomer comprises a second monomer represented by a formula (2), 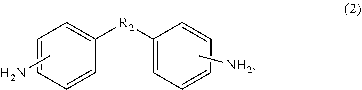
wherein R₂ is a second silicon-containing bivalent organic substituent.

6. The electrode binder of claim 5, wherein R₂ is selected from the group consisting of 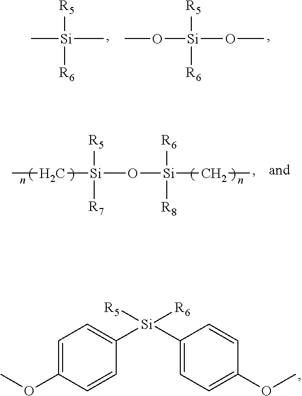
wherein n is in a range from 1 to 6; R₅, R₆, R₇, and R₈ are independently selected from the group consisting of an alkyl group with 1 to 6 carbon atoms, an alkoxy group with 1 to 6 carbon atoms, a monovalent alicyclic group, a monovalent substituted alicyclic group, a monovalent aromatic group, a monovalent substituted aromatic group, —C(O)R, —RS(O)R, and —RNH₂R, wherein R is an alkyl group with 1 to 6 carbon atoms.

7. The electrode binder of claim 5, wherein R₂ is selected from the group consisting of 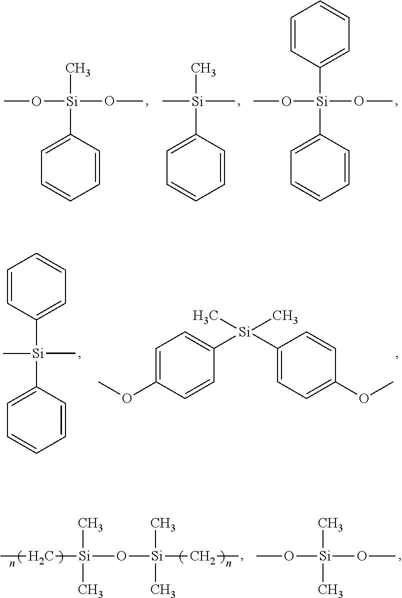
and —Si(CH₃)₂—.

8. The electrode binder of claim 5, wherein the dianhydride monomer comprises a third monomer represented by formulas (3), (4) or (5), 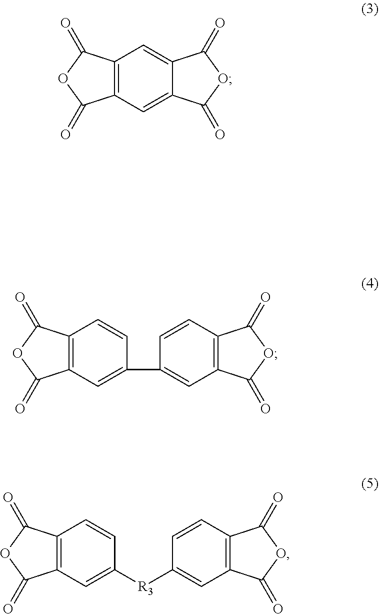
wherein R₃ is a third bivalent organic substituent containing no silicon atom.

9. The electrode binder of claim 2, wherein the diamine monomer comprises a fourth monomer represented by a formula (6), 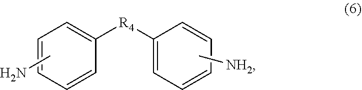
wherein R₄ is a fourth bivalent organic substituent containing no silicon atom.

10. The electrode binder of claim 1, wherein a molar ratio of a total amount of the silicon-containing monomer to a total amount of the silicon-free monomer is in a range from 1:100 to 10:1.

11. The electrode binder of claim 1, wherein at least one of the dianhydride monomer and the diamine monomer comprises a silicon-free monomer, a molar ratio of all of the silicon-containing monomer to all of the silicon-free monomer is in a range from 1:20 to 1:1.

12. The electrode binder of claim 1, wherein a molar ratio of all of the dianhydride monomer to all of the diamine monomer is in a range from 1:2 to 4:1.

13. The electrode binder of claim 1, wherein a molecular weight of the polymer obtained by polymerizing the dianhydride monomer with the diamine monomer is in a range from about 10000 to about 600000.

14. A cathode electrode material comprising a cathode binder, the cathode binder comprising a polymer obtained by polymerizing a dianhydride monomer with a diamine monomer, wherein at least one of the dianhydride monomer and the diamine monomer comprises a silicon-containing monomer.

15. The cathode electrode material of claim 14, wherein a mass percentage of the cathode binder in the cathode electrode material is in a range from about 1% to about 8%.

16. A lithium ion battery comprising:
a cathode electrode;
an electrolyte;
a separator; and
an anode electrode,
wherein the cathode electrode comprises a cathode active material, a conducting agent, and a cathode binder, the cathode binder comprises a polymer obtained by polymerizing a dianhydride monomer with a diamine monomer, wherein at least one of the dianhydride monomer and the diamine monomer comprises a monomer containing silicon atom.
